(19) United States
(12) Patent Application Publication
(10) Pub. No.: US 2009/0038193 A1
(43) Pub. Date: Feb. 12, 2009

(54) Signboard apparatus with scent diffusing function

(76) Inventors: Hsin-Lin Liu, Banciao City (TW); Jingshi Lin, Banciao City (TW)

Correspondence Address: BACON & THOMAS, PLLC, 625 SLATERS LANE, FOURTH FLOOR, ALEXANDRIA, VA, 22314-1176, US

(21) Appl. No.: 11/889,237

(22) Filed: Aug. 10, 2007

(51) Int. Cl. G09F 19/00; G09F 15/00

(52) U.S. Cl. 40/606.03; 40/406

(57) ABSTRACT

A signboard apparatus with scent diffusing function comprises a case including a containing space for accommodating the signboard and the scent material laminate; A plurality of scent diffusing pores are disposed in array of ventilating holes on the outer edge of the case so that it evaporates the odor of the scent material laminate out to purify and refresh the air in the surrounding closed space.

### BACKGROUND OF THE INVENTION

1. Technical Field

The present invention relates to a signboard apparatus with scent diffusing function, particularly for one having a scent material laminate accommodated in the case thereof so that the air in the surrounding closed space can be effectively purified and refreshed.

2. Prior Art

Coming along with the change of the society and the times, the consumers have much more choices in versatile and diversifying products owing to different new products are brought forth to eliminate the old one. For the purpose of effectively meeting such trend, the factories and stores try to make every effort to expose their products to the consumers as greatly as possibly so as not only to promote the sales volume but also to increase the business revenue.

Currently, the place where having stream of people mass gathered will always have all kinds of different product advertisements appeared there. For this reason, the elevator, lavatory, or patient ward of constant stream of people becomes the best site of the product advertisement. So far, the product advertisement appears in such closed space aforesaid is commonly the transparent signboard case with product adverting article fixed therein to catch attention of people who passing or visiting there for achieving the effect of propaganda advertisement.

However, the conventional propaganda advertisement signboard structure aforesaid can only achieve the effect of propaganda advertisement without any other derivative use such that it becomes very dull and bad as lacking of effectively enhancing the product competitiveness. Therefore, an improved signboard apparatus, which adds an audio-video device on the original transparent signboard case, appears recently so that it can achieve the propaganda advertisement object of the user for propaganda by multimedia Nevertheless, the multimedia propaganda by the audio-video device is still rather dull and bad because it can not derive new diversifying function yet to let consumer being impressed by the innovation.

Thus, it can be seen that both of the conventional signboard apparatus aforesaid are not good contrivance as some drawbacks, which are needed to be improved urgently, still exist therein.

In view of the foregoing issues and drawbacks in the conventional signboard apparatus aforesaid, the inventor of the present invention made a lot of efforts and invested tremendous painstaking care, spirit and energy in study, research, design, development and manufacturing in order to accumulate know-how and experience; eventually, the signboard apparatus with scent diffusing function of the present invention is successfully worked out.

### SUMMARY OF THE PRESENT INVENTION

The signboard apparatus with scent diffusing function for the present invention comprises a case, a signboard and a scent material laminate, wherein said case includes a containing space for accommodating the signboard and the scent material laminate; A plurality of scent diffusing pores are disposed in array of ventilating holes on the outer edge of the case so that it not only expedites the circulation of the air flow but also evaporates the odor of the scent material laminate out to the surroundings;

The signboard cell and scent material cell are configured in said containing space in separated manner so that either of which components can be singly replaced.

By means of the configuration of said scent material laminate, not only the effect of propaganda advertisement can be achieved but also the air in the surrounding space can be purified and refreshed; Additionally, the contents of said scent material laminate and signboard are freely selected to match each other so as to accomplish the multiple function and enhance the effect of the propaganda advertisement for improving the competitiveness of the signboard apparatus with scent diffusing function.

Moreover, the signboard in the case on the signboard apparatus of the present invention can be replaced by the audio-video device so that not only the effect of the propaganda advertisement can be promoted but also the effect in purifying air can be greatly increased owing to the heat produced by the audio-video device will catalyze the evaporation of the scent for the scent material laminate.

The primary object of the present invention is to provide a signboard apparatus with scent diffusing function so that the air in the surrounding closed space can be effectively purified and refreshed owing to the odor of the scent material laminate evaporated by the signboard apparatus.

The next object of the present invention is to provide a signboard apparatus with scent diffusing function so that the contents of said scent material laminate and signboard are freely selected to match each other so as to enhance the effect of the propaganda advertisement.

Another object of the present invention is to provide a signboard apparatus with scent diffusing function for having feature in simple structure and easy production.

The other object of the present invention is to provide a signboard apparatus with scent diffusing function for having advantages in simple assembly, operation and disassembly.

### BRIEF DESCRIPTION OF THE DRAWINGS

Please refer to the detailed description and accompanying drawings in association with the preferred exemplary embodiments in order to further understand the technological contents and objects as well as effects of the present invention. The accompanying drawings related to the exemplary embodiments are as below:

FIG. 1 is the perspective schematic view in exploded segments of the signboard apparatus with scent diffusing function for the present invention;

FIG. 2 is the perspective schematic view in structural assembly of the signboard apparatus with scent diffusing function for the present invention;

FIG. 3 is the perspective schematic view in structural disassembly of the signboard apparatus with scent diffusing function for the present invention;

FIG. 4 is the perspective schematic view in structural assembly of the signboard apparatus with scent diffusing function for another embodiment of the present invention; and

FIG. 5 is the perspective schematic view in structural assembly of the signboard apparatus with scent diffusing function for the other embodiment of the present invention.

### DETAILED DESCRIPTION OF THE PREFERRED EMBODIMENTS

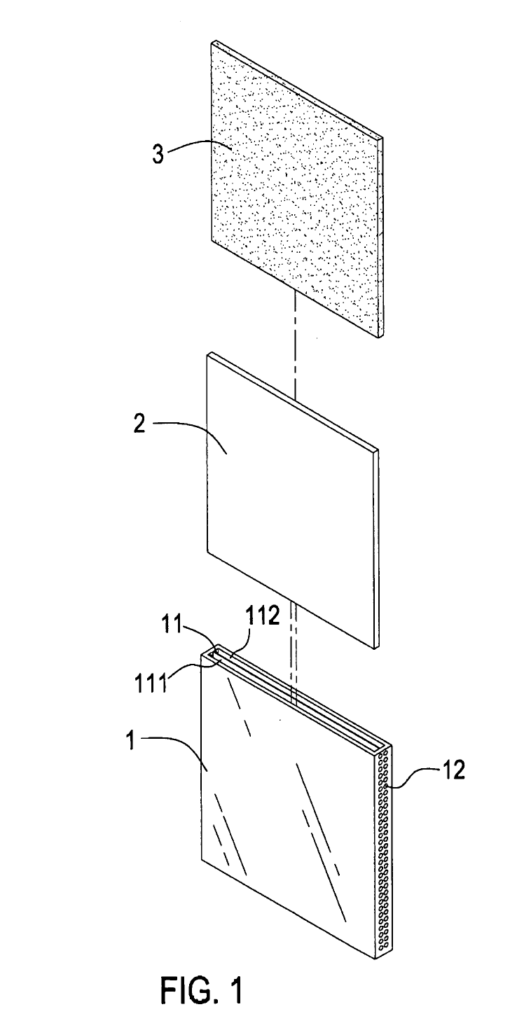

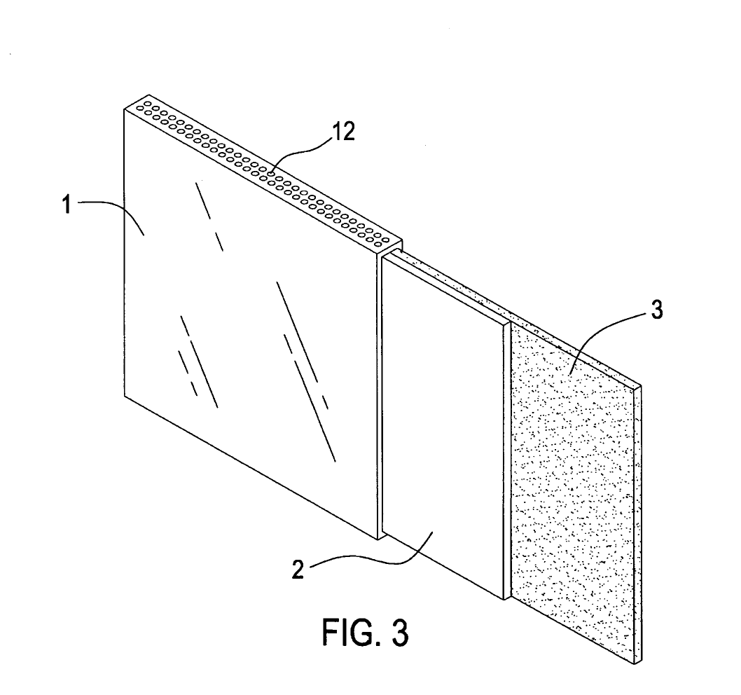

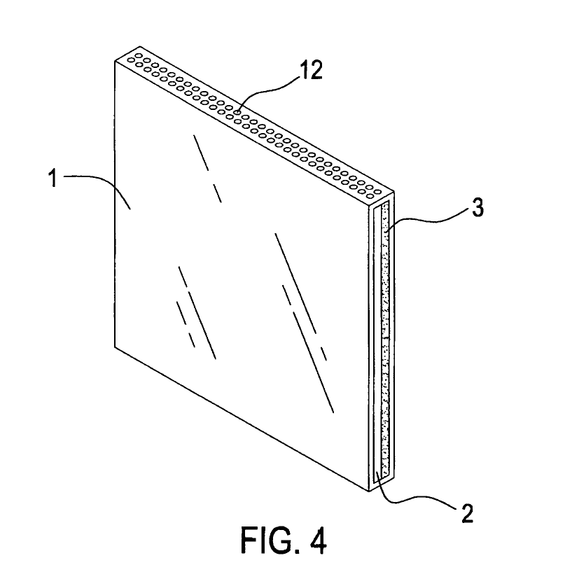

Please refer to the FIGS. 1 through 4, which are the perspective schematic views in exploded segments and in structural assembly of the signboard apparatus with scent diffusing function for the present invention, the signboard apparatus comprises a case 1, a signboard 2 and a scent material laminate 3, wherein:

Said case 1 includes a containing space 11 and many scent diffusing pores 12, among which said containing space 11 consists of a front signboard place 111, which accommodating the signboard 2, and a rear scent material place 112, which accommodating the scent material laminate 3; Said scent diffusing pores 12 are disposed in array of plurality ventilating holes on the outer edge of the case 1 so that it not only expedites the circulation of the air flow but also evaporates the odor of the scent material laminate 3 out to the surroundings;

Said signboard 2 is of any display type such as fluorescent light-backed transparent acrylic/glass sheet, neon-light signboard, illuminating panel and the like with propaganda advertisement article;

Said scent material laminate 3 is made of aromatic, freshener, tea brick and the like.

Said signboard place 111 and scent material place 112 in the containing space 11 can be adapted into separated signboard partition 111′ and scent material partition 112′, or be further adapted into separated signboard cell 111″ and scent material cell 112″ so that either of which components can be singly replaced.

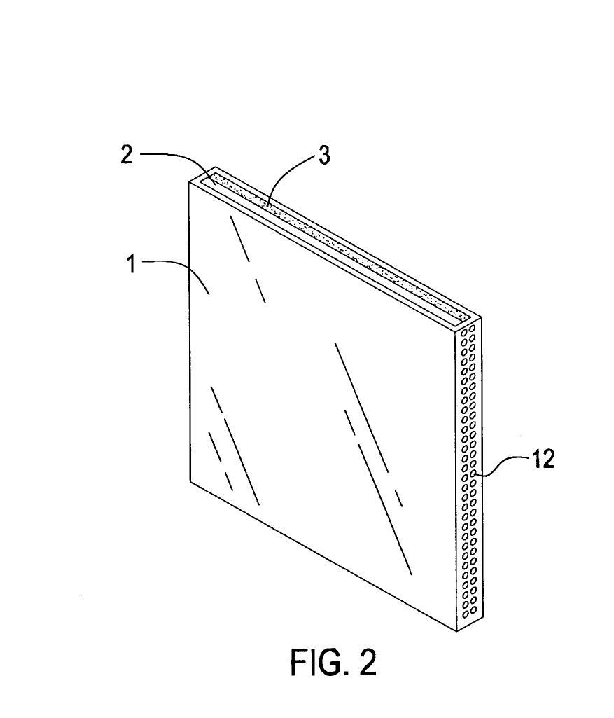

The case 1 aforesaid can be transparent housing such that it will not affect the function of the propagation advertisement. Besides, in said case 1, the up-and-down drawing swap for the opening direction of the containing space 11 (as shown in the FIGS. 1 and 2) for said signboard 2 with propaganda advertisement article can be adapted into the left-and-right drawing swap so that the contrived and produced signboard apparatus of the present invention can meet the different requirements of the application environment and jobsite.

By means of the configuration of said scent material laminate 3, not only the effect of propaganda advertisement can be achieved but also the air in the surrounding space can be purified and refreshed so as to accomplish the multiple function; Additionally, the contents of said scent material laminate 3 and signboard 2 are freely selected to match each other in order to enhance the effect of the propaganda advertisement for the signboard apparatus with scent diffusing function.

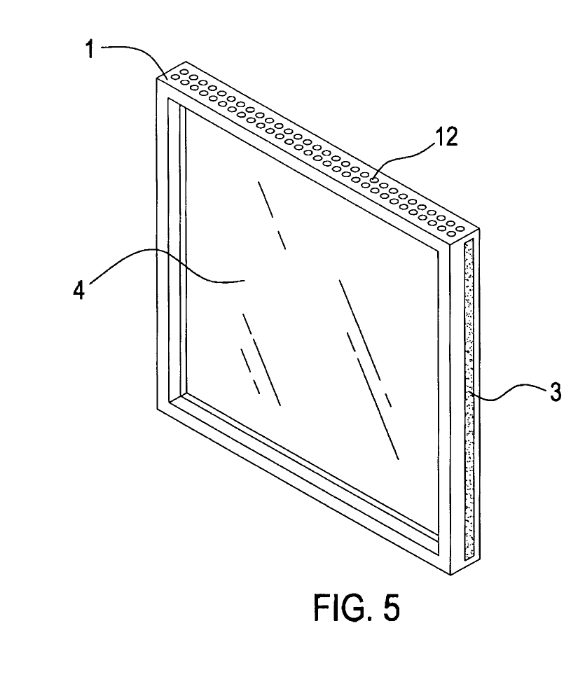

Please refer to the FIG. 5, which is the perspective schematic view in structural assembly of the signboard apparatus with scent diffusing function for the other embodiment of the present invention, the signboard 2 in the case 1 on the signboard apparatus of the present invention as depicted above can be replaced by the audio-video device 4; By means of such audio-video device 4, not only the effect of the propaganda advertisement can be promoted but also the effect in purifying air can be greatly increased owing to the heat produced by the audio-video device 4 will catalyze the evaporation of the scent for the scent material laminate 3.

The detailed disclosure hereinbefore is only a concrete description for some of preferred exemplary embodiments in the present invention. However, those embodiments are not deemed as the limitation of the claims for the present invention. Any equivalent modification, change, refinement and implement, which does not depart from the true technological essence and scope of the present invention, is intended to be covered by the claims of the present invention.

In conclusion from foregoing description, the present invention not only possesses the innovation on the structural pattern but also adds some new functions to the conventional signboard apparatus. Thus, the present meets the statutory patentable criterion of novelty, non-obviousness and practicable utility. Accordingly, we submit the patent application of the present invention to you in accordance with the relevant patent laws for your perusal and examination and earnestly appeal you for granting and issuing a patent for the present invention to encourage the invention motivation, which will be greatly obliged.

What is claimed is:

1). A signboard apparatus with scent diffusing function comprises a case, a signboard and a scent material laminate, wherein said case includes a containing space and many scent diffusing pores, among which said containing space consists of a front signboard place, which accommodating the signboard, and a rear scent material place, which accommodating the scent material laminate; Said scent diffusing pores are disposed in array of plurality ventilating holes on the outer edge of the case; Said signboard is of any display type such as fluorescent light-backed transparent acrylic/glass sheet, neon-light signboard, illuminating panel and the like with propaganda advertisement article.

2). The signboard apparatus with scent diffusing function as recited in the claim 1, wherein, said scent material laminate is made of aromatic, freshener, tea brick and the like.

3). The signboard apparatus with scent diffusing function as recited in the claim 1, wherein, said signboard place and scent material place in the containing space are adapted into separated signboard partition and scent material partition, or are further adapted into separated signboard cell and scent material cell so that either of which components can be singly replaced.

4). The signboard apparatus with scent diffusing function as recited in the claim 1, wherein, said signboard in the case is replaced by the audio-video device so that not only the effect of the propaganda advertisement can be promoted but also the effect in purifying air can be greatly increased.
